(19) United States
(12) Patent Application Publication
(10) Pub. No.: US 2004/0134938 A1
(43) Pub. Date: Jul. 15, 2004

(54) Hand held, dip-tube pump style fluid dispenser

(76) Inventor: Rosa Alexandra Shand, Jupiter, FL (US)

Correspondence Address: ROSA A. SHAND, 18771 STILL LAKE DRIVE, JUPITER, FL, 33458, US

(21) Appl. No.: 10/713,932

(22) Filed: Nov. 14, 2003

Related U.S. Application Data
(60) Provisional application No. 60/427,453, filed on Nov. 20, 2002.

(51) Int. Cl. B67D 5/40

(52) U.S. Cl. 222/377

(57) ABSTRACT

A hand held, dip-tube style fluid pump dispenser comprising a container having an inclined upper neck or an incline upper male screw for attachment with the female threads or locking mechanism of the spray or pumping device or dispensing device positioned adjacent to this upper end for dispensing a fluid held in the container and communicated upward to the dispensing device. The inclined upper neck directs the center axis of the dip-tube away from the center of the container and towards the front of the lower portion of the container. The dip-tube being of a sufficient length such that the lower end of the dip-tube is urged toward the front side lowermost portion of the bottom of the container to avoid prime lost of the pump when the container is oriented as in use.

### CROSS REFERENCE TO RELATED APPLICATIONS:

References Cited

U.S. patent Documents

| | | |
|---|---|---|
| 4220285 | Sep. | 1980 Gualdi et al. 222/383 |
| 4273272 | Jun. | 1981 Blanc 222/464 |
| 4461406 | Jul. | 1984 Vannucci 222/211 |
| 4470526 | Sep. | 1984 Cha et al. 222/382 |
| 4830235 | May. | 1989 Miller 222/464 |
| 5062549 | Nov. | 1991 Smith 222/337 |
| 5464129 | Nov. | 1995 Ho 222/377 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM COMPACT DISK APPENDIX

Not Applicable

### BACKGROUND AND DESCRIPTION OF THE INVENTION

The present invention relates to hand held dispensing apparatus for liquids or any other kind of fluids, and more particularly to hand held, dip-tube style liquid dispensers. In another aspect, the invention relates to an improvement in hand held, dip-tube style spray dispensers for fluids.

Dip-tube style dispensers and dip-tube style spray dispensers for fluids particularly have widespread consumer acceptance and appeal. Such hand held dispensers are used for dispensing a variety of fluids and for a variety of uses, from dispensing window cleaning products to dispensing soap for home use. Uniformly, however, the tilting or inclination of containers for these dispensers in use and the placement of a lower end of the dip-tube are such that before all of the fluid is evacuated from a container, prime is lost and the user of the device must remove and perhaps apply or use the remaining fluid in some less convenient or efficacious way. The necessity of undertaking to remove the remaining fluid, which may or may not be substantial in volume, naturally has the effect of reducing the appeal of such dip-tube style dispensers for fluids.

### BRIEF SUMMARY OF THE INVENTION

A hand held, dip-tube style fluid pump dispenser comprising a container having an inclined upper neck or an incline upper male screw for attachment with the female threads or locking mechanism of the spray or pumping device or dispensing device positioned adjacent to this upper end for dispensing a fluid held in the container and communicated upward to the dispensing device. The sidewalls extending upwardly from the bottom, a standard or regular bottom, and a dip-tube for pumping fluid upward from a lower end of the tube to the dispensing device. The tube being of a sufficient length such that the lower end of the tube is urged toward the front side lowermost portion of the bottom to avoid prime lost of the pump when the container is oriented as in use.

The purpose of the inclined upper neck or an inclined upper male screw for attachment with the female threads or locking mechanism of the spray or pumping device is to direct the center axis of the dip-tube away from the center of the container and towards the front of the lower portion of the container. When the container is oriented as in use the fluid inside the container concentrates in the front lowermost area of the bottom of the container. The tilting or inclining of the neck directs the dip-tube to the area where the fluid concentrates when the container is oriented as in use.

### BRIEF DESCRIPTION OF THE SEVERAL VIEWS OF THE DRAWING

FIG. 1 is a side view of a first embodiment of the instant invention with the spray pump pointing to the front of the container.

FIG. 2 is a side view of a first embodiment of the instant invention with the spray pump pointing to the back of the container.

FIG. 3 is a side view of a first embodiment of the instant invention with the spray pump dip-tube pointing down to the lower front of the container.

FIG. 4 is a side view of a first embodiment of the instant invention with the spray pump pointing to a downward area as if in use to spray a fluid to a horizontal surface.

FIG. 5 is a side view of a second embodiment of the instant invention with the spray pump pointing to the front of the container.

FIG. 6 is a side view of a second embodiment of the instant invention with the spray pump pointing to a downward area as if in use to spray a fluid to a horizontal surface.

FIG. 7 is a side view of a second embodiment of the instant invention with the spray pump pointing to an upward area as if in use to spray a fluid to a high area.

### DETAILED DESCRIPTION OF THE INVENTION

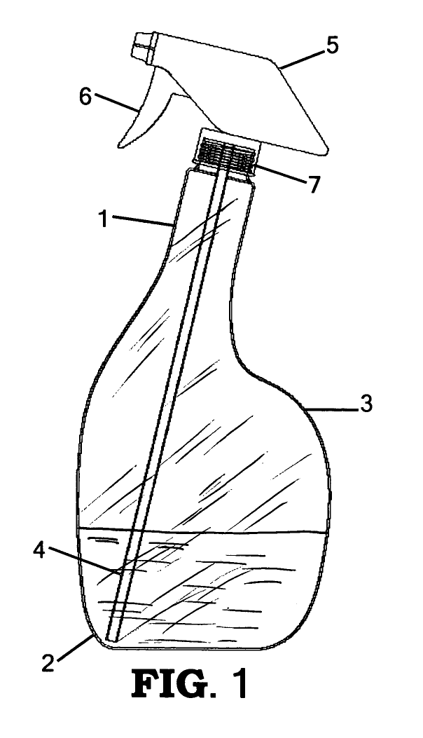

Referring now to the drawings, in which same reference characters denote similar throughout the several views, FIG. 1 is a side view of a first embodiment of the instant invention with the spray pump head 5 and pump trigger 6 pointing to the front 2 of the container 3. The dip-tube 4 is coupled to the pump head. This image shows the neck 1 of the spray bottle inclined in order to direct the dip-tube 4 to the front lowermost area 2 of the container 3. FIG. 1 shows the bottle, as it would position itself on a flat horizontal surface. The container 3 has an upper externally threaded neck 7 to connect to the internally threaded cap of the pump head 5.

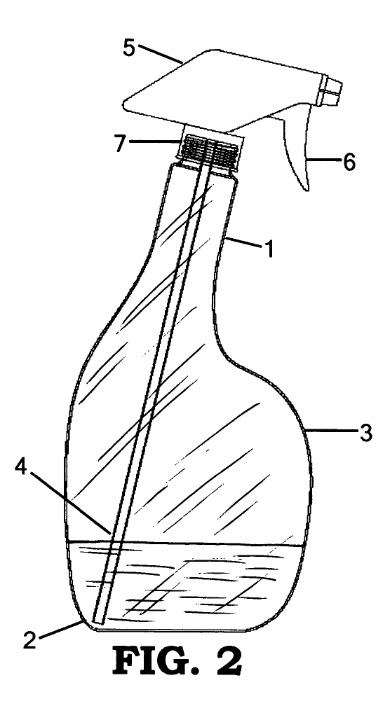

FIG. 2 is a side view of a first embodiment of the instant invention with the spray pump 5 pointing to the back of the container 3. This image shows the spray bottle, as it would position itself on a flat horizontal surface.

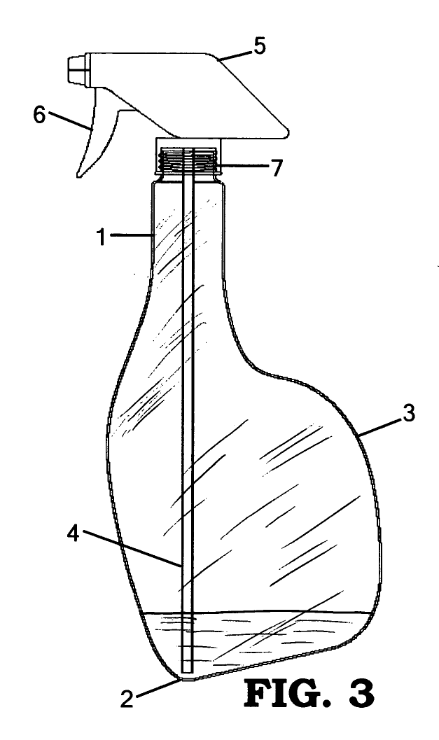

FIG. 3 is a side view of a first embodiment of the instant invention with the spray pump dip-tube 4 pointing down to the lower front 2 of the container 3. This view shows that even if a small amount of fluid remains in the bottle, the pump 5 will not loose prime.

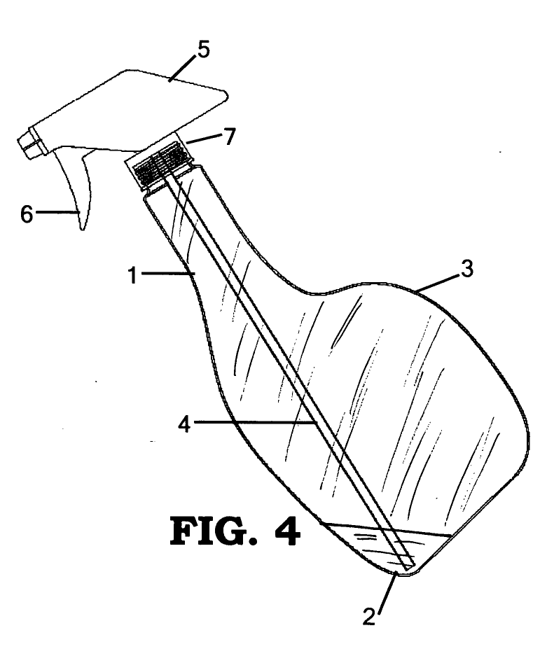

FIG. 4 is a side view of a first embodiment of the instant invention with the spray pump 5 pointing to a downward area as if in use to spray a fluid to a horizontal surface. The spray pump dip-tube 4 points down to the lower front 2 of the container 3.

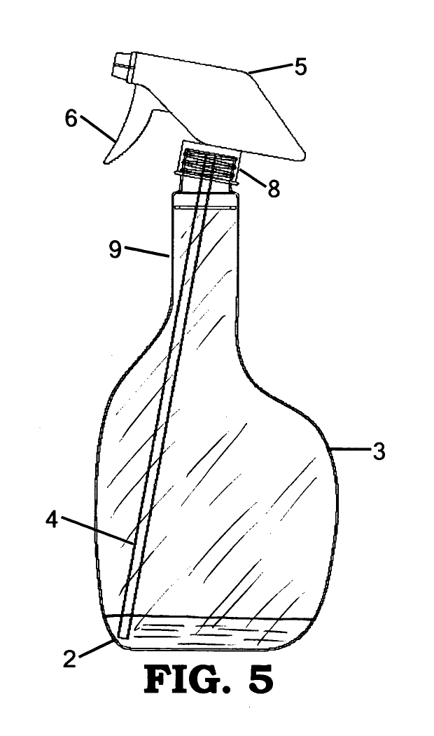

FIG. 5 is a side view of a second embodiment of the instant invention with the spray pump 5 pointing to the front 2of the container. This image shows the spray bottle, as it would position itself on a flat horizontal surface. The dip-tube 4 points to the front 2 of the container. Only the externally threaded neck 8 of the bottle if inclined back on this second alternative embodiment of the present invention.

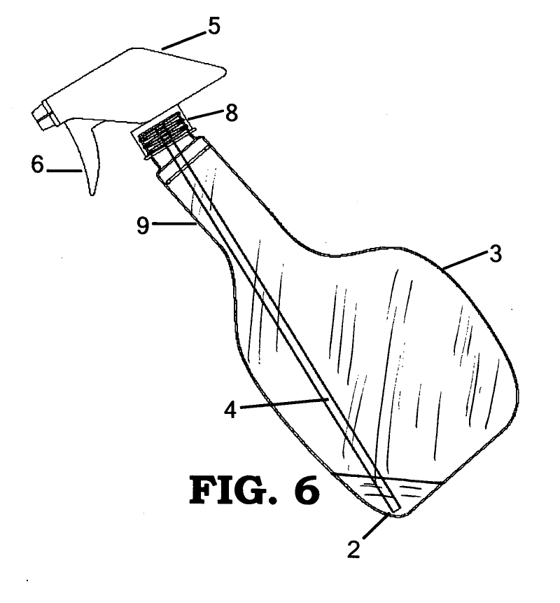

FIG. 6 is a side view of a second embodiment of the instant invention with the spray pump 5 and trigger 6 pointing to a downward area as if in use to spray a fluid to a horizontal surface. The spray pump dip-tube 4 points down to the lower front 2 of the container 3.

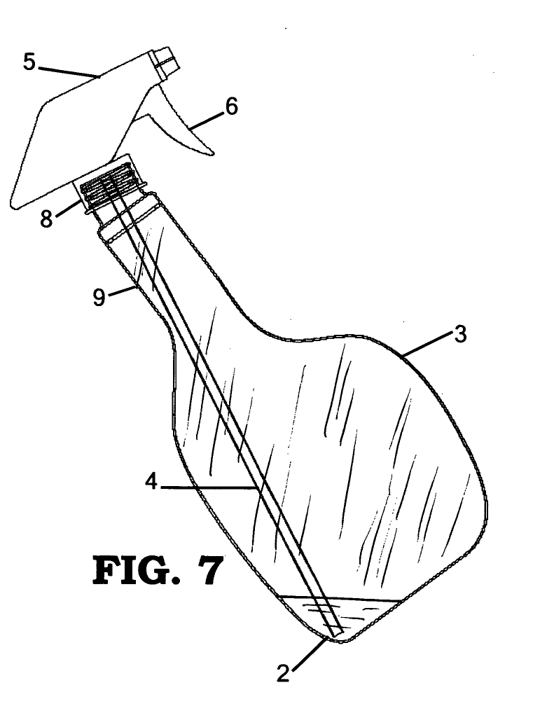

FIG. 7 is a side view of a second embodiment of the instant invention with the spray pump 5 and trigger 6 pointing to an upward area as if in use to spray a fluid to a high area. The spray pump dip-tube 4 points down to the lower portion 2 of the container 3 in order to avoid of lost of prime to the pump 5.

The primary difference of the two embodiments of the instant invention if that in the first case (FIGS. 1 to 4) the neck is inclined backwards in order to direct the centerline of the dip-tube away from the center of the container and toward the front lowermost area. In the second embodiment of the invention (FIGS. 5 to 7) only the threaded portion of the neck is inclined or tilted backward to position the dip-tube 4 to the front lowermost area 2 of the container 3 to receive all of the fluid within the container.

### MANUFACTURING OF THE INVENTION

Similar manufacturing processes and materials that are used worldwide to produce regular spray pump style bottles can be used to manufacture containers that could incorporate my invention of a bottle with a tilted neck or a tilted threaded neck.

### OPERATION OF THE INVENTION

To use the improved hand held, dip-tube pump dispenser, the following steps should follow:

1. Remove the spray pump 5 from the container.

2. Fill the container 3 with a fluid to be dispensed therefrom.

3. Replace the pump head 5 onto the container.

4. Compress the pump head trigger with your finger several times until fluid is dispensed from the pump.

It is understood that each of the elements described above, or two or more together may also find a useful application in other types of methods differing from the types described above. While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A hand held, non-pressurized, dip-tube style fluid pump dispenser comprising:
A container having an inclined upper neck in order to direct the center axis suction dip-tube to the lower front end of the container;
dispensing means positioned adjacent said inclined upper neck of said container for dispensing a fluid held in said container and communicated upward to said dispensing means; a dip-tube for communicating said fluid upward from a lower front end of said dip-tube to said dispensing means, said dip-tube will be directed to the front, lower portion of the hand held fluid container, said dip-tube being directed by the inclined neck of the containers to the front bottom end, said dip-tube being of a sufficient length such that the lower end of the tube is urged by the inclined upper neck of the dispenser toward the front side lowermost portion of the bottom to avoid prime lost of the pump when the container is oriented as in use and said dip-tube will no be vertical when the container is positioned on a flat, horizontal surface.

2. A hand held, non-pressurized, dip-tube style fluid pump dispenser comprising:
A container having an inclined upper male threaded portion at the end of the neck for attachment with the female threads or locking mechanism of the spray or pumping device in order to direct the center axis suction dip-tube to the lower front end of the container;
dispensing means positioned adjacent said inclined upper threaded end of said container for dispensing a fluid held in said container and communicated upward to said dispensing means; a dip-tube for communicating said fluid upward from a lower front end of said dip-tube to said dispensing means, said dip-tube will be directed to the front, lower portion of the hand held fluid container, said dip-tube being directed by the inclined threaded neck of the container to the front bottom end, said dip-tube being of a sufficient length such that the lower end of the tube is urged by the inclined upper neck of the dispenser toward the front side lowermost portion of the bottom to avoid prime lost of the pump when the container is oriented as in use and said dip-tube will no be vertical when the container is positioned on a flat, horizontal surface.
